(19) United States
(12) Patent Application Publication
(10) Pub. No.: US 2018/0036660 A1
(43) Pub. Date: Feb. 8, 2018

(54) PRE-FILTERING DEVICE AND METHOD THEREOF

(71) Applicant: Xiamen Runner Industrial Corporation, Xiamen (CN)

(72) Inventors: HONG-KUN XU, Xiamen (CN); FENG-SHUN ZHAN, Xiamen (CN)

(21) Appl. No.: 15/667,508

(22) Filed: Aug. 2, 2017

(30) Foreign Application Priority Data
Aug. 3, 2016 (CN) 201610627772.7

(51) Int. Cl. B01D 29/00; B01D 29/56

(52) U.S. Cl. CPC B01D 29/0059; B01D 29/56

(57) ABSTRACT

A filtering device includes a hollow body, a filtering core assembly securely received inside the body and composed of an outer filtering core and an inner filtering core securely received inside the outer filtering core. A first switch device is mounted at a bottom end of the body and operably connected to a bottom of the filtering core assembly. A second switch device is mounted at a top end of the body and operably connected to a top of the filtering core assembly. A first chamber is defined between an inner face of the body and an outer periphery of the outer filtering core. A second chamber is defined an inner periphery of the outer filtering core and an outer periphery of the inner filtering core. A third chamber is defined inside the inner filtering core, wherein the first switch device controls communication between the first chamber and the second chamber.

### CROSS REFERENCE

This application claims the priority of Chinese Application No. 201610627772.7, filed on Aug. 3, 2016 and the entirety thereof is herein incorporated with reference.

### TECHNICAL FIELD

The preferred embodiment of the present invention is related to a field of water filtering device and, more particularly, to a pre-filtering device having therein multiple filtering cores.

### BACKGROUND OF THE INVENTION

Physical filtering is largely adopted by a conventional filtering device. That is, a filtering core made of steel is normally used to filter out large particles or objects, such as sand, debris or even algae to protect waterways in household appliances from blocking. The number of mesh used in the filter device has an important influence on the filtering effect. That is, the greater the number is, the greater filtering effect. By contrast, the fewer the number is, the filtering effect becomes worse. However, the pursuit of fine mesh may lead to the blockage of the mesh by particles and/or contaminant in the water and cleaning of the mesh is not only inevitable, but the frequency is largely increased.

In order to solve the problem, the commercial solution is to provide a filtering device adaptable for meshes so that the operator is able to change the mesh according to the local water quality.

### SUMMARY OF THE INVENTION

It is an objective of the preferred embodiment of the present invention to provide a filtering device having therein multiple filtering cores of different meshes.

In order to accomplish the abovementioned objective, the filtering device constructed in accordance with the preferred embodiment of the present invention includes an annular hollow body, a filtering core assembly securely received inside the hollow body, a first switch device mounted and operatably connected to a bottom end of the filtering core assembly and a second switch device mounted and operatably connected to a top end of the filtering core assembly. The filtering core assembly is composed of an outer filtering core and an inner filtering core securely received inside the outer filtering core. A first chamber is defined between an inner face of the annular hollow body and an outer periphery of the outer filtering core. A second chamber is defined between an inner periphery of the outer filtering core and an outer periphery of the inner filtering core. An internal space of the inner filtering core is defined as a third chamber. The first switch device is responsible for the communication between the first chamber and the second chamber.

In another objective of the preferred embodiment of the present invention, the second switch device has an inlet, an outlet, a second switch valve located adjacent to the inlet and the outlet, a first passage defined close to the inlet and a second passage defined close to the outlet. When the second switch valve is operated and at its first position, the first passage communicates with the first chamber and the second passage communicates with the third chamber. When the second switch valve is at its second position, the first chamber communicates with the third chamber, while the third chamber is not communicating with the second passage and the outlet.

Still another objective of the preferred embodiment of the present invention is that the inner filtering core is annular in shape and open to the top and close at the bottom. The outer filtering core is also constructed in annular shape and open at both ends. The outer filtering core has a mesh number of 50-200 mesh, which is fewer than that of the inner filtering core, i.e., 300-600.

In addition to the above, still another objective of the preferred embodiment of the present invention is that a fourth chamber is defined between an outer periphery of the first switch device and the inner periphery of the annular body and communicates with the first chamber. A recess is defined in a top portion of the first switch device to communicate with the second chamber. It is to be noted that the first switch device is responsible for the communication between the recess as well as the second chamber and the first chamber as well as the fourth chamber.

In addition to the above, still another objective of the preferred embodiment of the present invention is that a drainage is mounted at the bottom of the first switch device and provided with a manual switch.

In addition to the above, still another objective of the preferred embodiment of the present invention is that the second switch device is a three-way valve device with a sleeve rotatably extended therein and controlled by a knob rotatably mounted on top of the three-way valve device. The sleeve is open at its bottom and has an aperture defined in a side face thereof and a boss formed on the side face below the aperture to be responsible for the communication between the inlet and the first chamber.

The first switch device includes a base with the recess defined therein, a shaft and a cover. The shaft is composed of a disk and a rotary sleeve integrally extended downward from the disk. The disk has a cutout defined in a peripheral sidewall thereof and the base has a waterway in communication with the cutout via the recess. The rotary sleeve has a water passage defined through a side face thereof. The cover receives therein the base and the disk while the rotary sleeve extends out of the cover to engage with a knob. A bottom end of the rotary sleeve is connected to the inlet of the drainage. Therefore, when the first switch is functioning and in a closed status, water cannot flow from the recess to the fourth chamber. However, when the first switch device is in an open status, water flows from the recess to the fourth chamber via the waterway and the cutout of the disk. The water passage is used to allow the water in the fourth chamber to flow to the drainage via the rotary sleeve.

Still another objective of the preferred embodiment of the present invention is that the first switch device includes a base having therein a recess, a static disk, a dynamic disk, a shaft and a cover. The shaft includes a disk and a rotary sleeve integrally extended downward from a bottom side face of the disk. The disk is disengagably connected to the dynamic disk. The dynamic disk has a cutout defined in a side wall thereof. The static disk defined therein a waterway through which water flows from the recess to the cutout of the dynamic disk. The rotary sleeve has a water passage defined in a side face thereof and the cover covers the base as well as the outer periphery of the disk. The rotary sleeve extends out of the cover to engage with a knob. A bottom end of the rotary sleeve is connected to the inlet of the drainage. Therefore, when the first switch is functioning and in a closed status, water cannot flow from the recess to the fourth chamber. However, when the first switch device is in an open status, water flows from the recess to the fourth chamber via the waterway and the cutout of the disk. The water passage is used to allow the water in the fourth chamber to flow to the drainage via the rotary sleeve.

### BRIEF DESCRIPTION OF THE DRAWINGS

FIG. 1 is a schematic cross-sectional view of the filtering device of the preferred embodiment of the present invention;

FIG. 2 is an exploded plan view of the filtering device shown in FIG. 1 of the preferred embodiment of the present invention;

FIG. 3 is an exploded perspective view of a filtering core assembly of the preferred embodiment of the present invention;

FIG. 4 is a schematic cross-sectional view showing water flow in a normal filtering status;

FIG. 5 is a schematic cross-sectional view showing waterflow cleaning the outer filtering core;

FIG. 6 is a schematic cross-sectional view showing waterflow cleaning the inner filtering core;

FIG. 7 is a schematic cross-sectional view showing waterflow cleaning the outer filtering core in a different manner from that of FIG. 5;

FIG. 8 is an exploded perspective view showing the first switch device of the preferred embodiment of the present invention; and

FIG. 9 is still an exploded perspective view showing the first switch device of the preferred embodiment of the present invention.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 1, wherever a part feature appears in a text, an associated serial number is directly assigned.

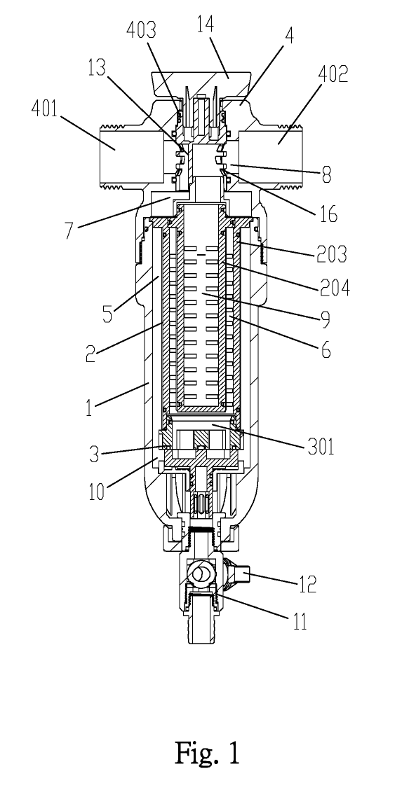

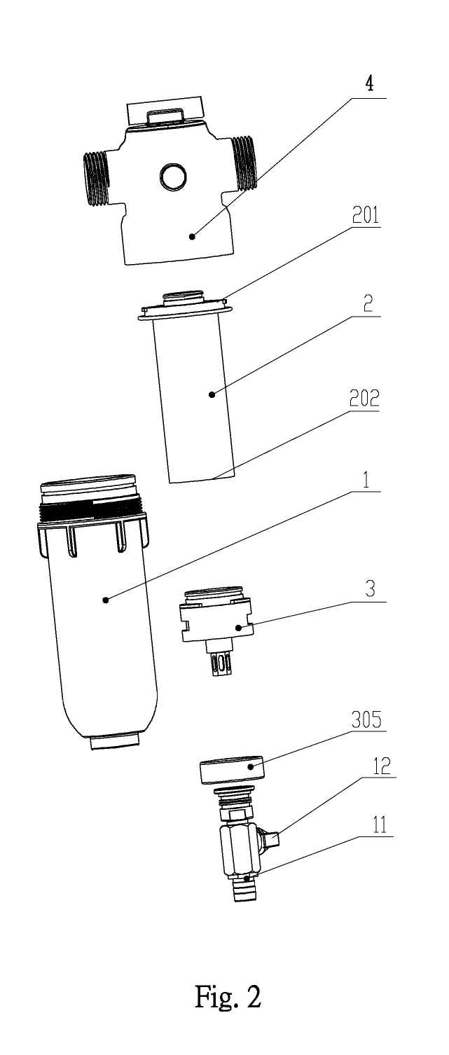

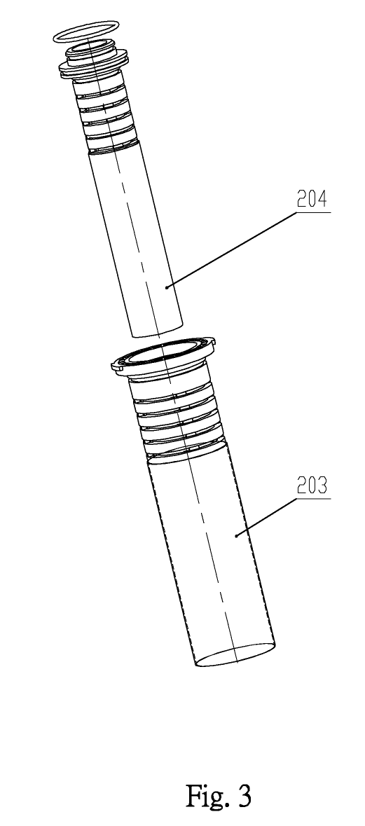

With reference to FIGS. 1, 2 and 3, the water filtering device constructed in accordance with the preferred embodiment of the present invention includes an annular hollow body 1, a filtering core assembly 2 securely received inside the hollow body 1, a first switch device 3 mounted and operatably connected to a bottom end of the filtering core assembly 2 and a second switch device 4 mounted and operatably connected to a top end of the filtering core assembly 2. The filtering core assembly is composed of an outer filtering core 203 and an inner filtering core 204 securely received inside the outer filtering core 203. A first chamber 5 is defined between an inner face of the annular hollow body 1 and an outer periphery of the outer filtering core 203. A second chamber 6 is defined between an inner periphery of the outer filtering core 203 and an outer periphery of the inner filtering core 204. An internal space of the inner filtering core 204 is defined as a third chamber 9. The first switch device 3 is responsible for the communication between the first chamber 5 and the second chamber 6.

The second switch device 4 has an inlet 401, an outlet 402, a second switch valve 403 located adjacent to the inlet 401 and the outlet 402, a first passage 7 defined close to the inlet 401 and a second passage 8 defined close to the outlet 402. When the second switch valve 403 is operated and at its first position, the first passage 7 communicates with the first chamber 5 and the second passage 8 communicates with the third chamber 9. When the second switch valve 403 is at its second position, the first chamber 5 communicates with the third chamber 9, while the third chamber 9 is not communicating with the second passage 6 and the outlet 402.

The inner filtering core 204 is annular in shape and open to the top and close at the bottom. The outer filtering core 203 is also constructed in annular shape and open at both ends. The outer filtering core 203 has a mesh number of 50-200 mesh, which is fewer than that of the inner filtering core 204, i.e., 300-600.

In addition to the above, a fourth chamber 10 is defined between an outer periphery of the first switch device 3 and the inner periphery of the annular body 1 and communicates with the first chamber 5. A recess 301 is defined in a top portion of the first switch device 3 to communicate with the second chamber 6. It is to be noted that the first switch device 3 is responsible for the communication between the recess 301 as well as the second chamber 6 and the first chamber 5 as well as the fourth chamber 10.

A drainage 11 is mounted at the bottom of the first switch device 3 and provided with a manual switch 12.

The second switch device 4 is a three-way valve device with a sleeve 13 rotatably extended therein and controlled by a knob 14 rotatably mounted on top of the three-way valve device. The sleeve 13 is open at its bottom and has an aperture 16 defined in a side face thereof and a boss 15 formed on the side face below the aperture 16 to be responsible for the communication between the inlet 401 and the first chamber 5. When the knob 14 is rotated to activate (open) the second switch device 4, the aperture 16 communicates with the third chamber 9 and the outlet 402 so that after water from the water source flows through the inlet 401, the first passage 7 and enters the first chamber 5. When the knob 14 is rotated again to allow the filtering device of the preferred embodiment of the present invention to enter still another cleaning status, the aperture 16 communicates with the inlet 401 and the third chamber 9 so that the water from the water source directly enters the third chamber 9, while the water cannot enter the first passage, the first chamber 5 as well as the outlet 402.

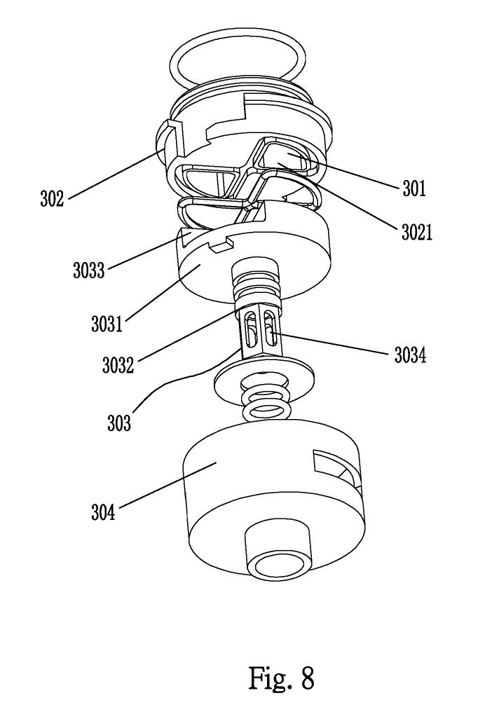

With reference to FIG. 8, the first switch device 3 includes a base 302 with the recess 301 defined therein, a shaft 303 and a cover 304. The shaft 303 is composed of a disk 3031 and a rotary sleeve 3032 integrally extended downward from the disk 3031. The disk 3031 has a cutout 3033 defined in a peripheral sidewall thereof and the base 302 has a waterway 3021 in communication with the cutout 3033 via the recess 301. The rotary sleeve 3032 has a water passage 3034 defined through a side face thereof. The cover 304 receives therein the base 302 and the disk 3031 while the rotary sleeve 3032 extends out of the cover 304 to engage with a knob 305. A bottom end of the rotary sleeve 3032 is connected to the inlet of the drainage 11. Therefore, when the first switch 3 is functioning and in a closed status, water cannot flow from the recess 301 to the fourth chamber 10. However, when the first switch device 3 is in an open status, water flows from the recess 301 to the fourth chamber 10 via the waterway 3021 and the cutout 3033 of the disk 3031. The water passage 3034 is used to allow the water in the fourth chamber 10 to flow to the drainage 11 via the rotary sleeve 3032.

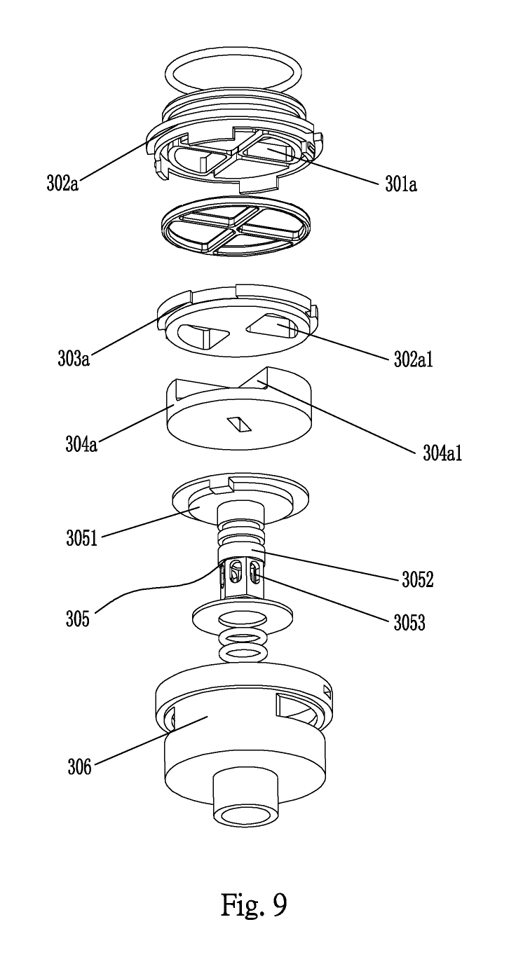

With reference to FIG. 9, another embodiment of the first switch device is shown, wherein the first switch device 3 includes a base 302a having therein a recess 301a, a static disk 303a, a dynamic disk 304a, a shaft 305 and a cover 306. The shaft 305 includes a disk 3051 and a rotary sleeve 3052 integrally extended downward from a bottom side face of the disk 3051. The disk 3051 is disengagably connected to the dynamic disk 304a and are rotated together. The dynamic disk 304a has a cutout 304a1 defined in a side wall thereof. The static disk 303a defines therein a waterway 302a1 through which water flows from the recess 301a to the cutout 304a1 of the dynamic disk 304a. The rotary sleeve 3052 has a water passage 3053 defined in a side face thereof and the cover 306 covers the base 302a as well as the outer periphery of the disk 3051. The rotary sleeve 3052 extends out of the cover 306 to engage with a knob 12. A bottom end of the rotary sleeve 3052 is connected to the inlet of the drainage 11. Therefore, when the first switch 3 is functioning and in a closed status, water cannot flow from the recess 301a to the fourth chamber 10. However, when the first switch device 3 is in an open status, water flows from the recess 301a to the fourth chamber 10 via the waterway 302a1 and the cutout 304a1 of the dynamic disk 304a. The water passage 3053 is used to allow the water in the fourth chamber 10 to flow to the drainage 11 via the rotary sleeve 3052.

### Waterflow in Different Filtering Status

### A

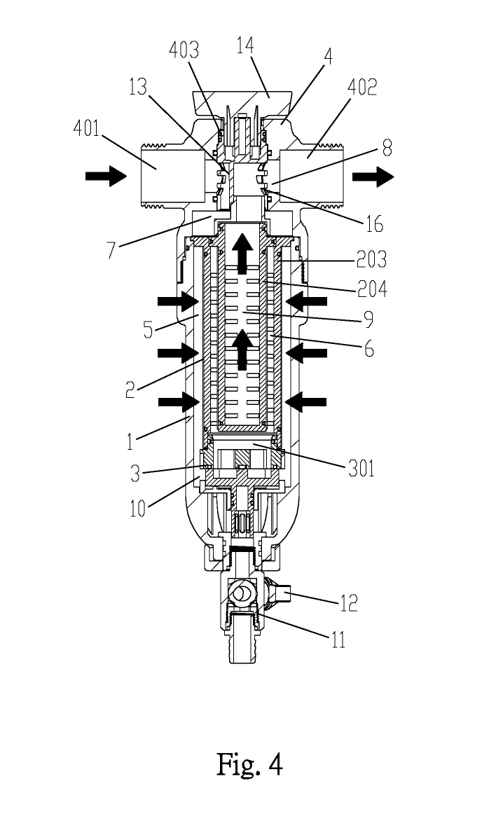

When in filtering, the first switch device 3 as well as the drainage 11 is closed and the second switch device 4 is at its first position, the first passage 7 communicates with the first chamber 5 and the second passage 8 communicates with the third chamber 9, while the first passage 7 is blocked from communication with the recess 301 such that water from the water source flows through the first passage 7, the first chamber 5, the outer filter core 203, the inner filter core 204, the third chamber 9, the second passage 8 and exits the outlet 402, as shown in FIG. 4.

B with the Drainage 11 Open

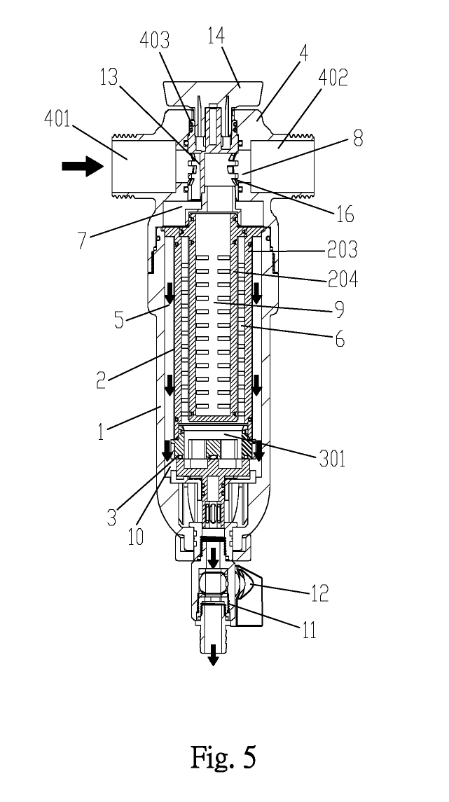

While the second switch device 4 is still at its first position, the first passage 7 communicates with the first chamber 5 but the recess 301. As the path from the first passage 7, the first chamber 5, the fourth chamber 10, the internal space inside the rotary sleeve 3032 to the drainage 11 is free from any blockage, water from the water source flows through the inlet 402, the first passage 7, the fourth chamber 10, the internal space of the rotary sleeve 3032 and exits the drainage 11, which directly fulfills the objective of cleaning the outer periphery of the outer filter core 203, as shown in FIG. 5.

C with the First Switch Device as Well as the Drainage Open

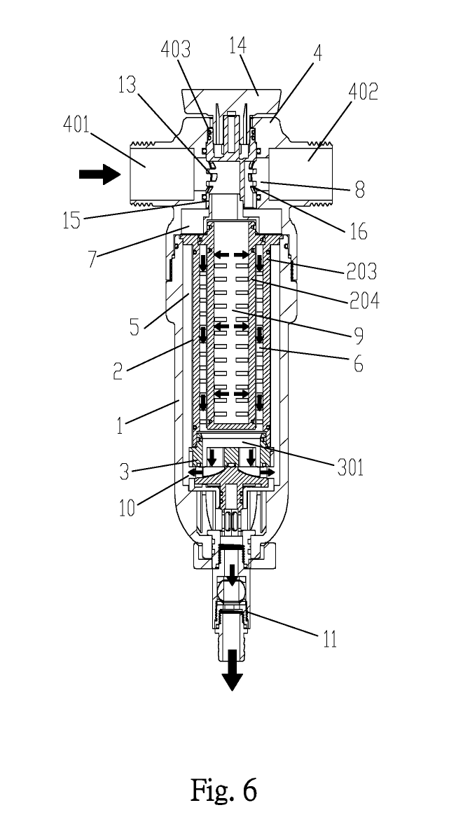

The first passage 7 communicates with the third chamber 9 while the third chamber 9 is blocked from communication with the second passage 8 and the outlet 402. The recess 301 communicates with the fourth chamber 10 so that water from the water source flows through the inlet 401, the first passage 7 and enters the third chamber 9. After water enters the internal space of the third chamber 9, water may easily flow through the mesh of the inner filter core 204 and reaches the space of the second chamber 6. After cleaning both the inner filter core 204 and the internal surface of the outer filter core 203, water may easily flow through the second chamber 6, the recess 301, the fourth chamber 10, the internal space of the rotary sleeve 3032 and exits from drainage 11, as shown in FIG. 6.

D with the First Switch Device Closed and the Drainage Open

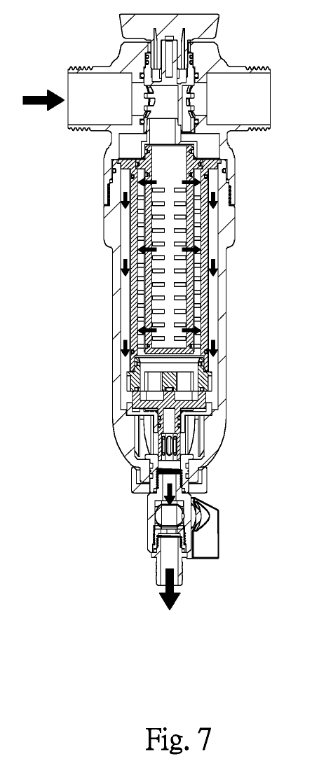

In this status, the first passage 7 communicates with the third chamber 9, while the third chamber 9 is blocked from communication with the second passage 8 and the outlet 402. The recess 301 also is blocked from communication with the fourth chamber 10 such that water from the water source flows through the inlet 401, the first passage 7 and directly enters the third chamber 9. After which, water flows through the second chamber 6, the first chamber 5, the fourth chamber 10, the internal space of the rotary sleeve 3032 and exists from the drainage 11, as shown in FIG. 7.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A filtering device comprising:
a hollow body;
a filtering core assembly securely received inside the body and composed of an outer filtering core and an inner filtering core securely received inside the outer filtering core;
a first switch device mounted at a bottom end of the body and operably connected to a bottom of the filtering core assembly;
a second switch device mounted at a top end of the body and operably connected to a top of the filtering core assembly;
a first chamber defined between an inner face of the body and an outer periphery of the outer filtering core;
a second chamber defined an inner periphery of the outer filtering core and an outer periphery of the inner filtering core;
a third chamber defined inside the inner filtering core, wherein the first switch device controls communication between the first chamber and the second chamber.

2. The filtering device as claimed in claim 1, wherein the second switch device includes an inlet, an outlet, a switch valve provided adjacent to the inlet and the outlet, a first passage defined close to the inlet, a second passage defined close to the outlet such that when the switch valve is at its first position, the first passage communicates with the first chamber and the second passage communicates with the third chamber, while the switch valve is at its second position, the first passage communicates with the third chamber and the third chamber is blocked from communication with the second passage and the outlet.

3. The filtering device as claimed in claim 1, wherein the inner filtering core is annular in shape and open to the top and close at its bottom end while the outer filtering core is open at both ends, the outer filtering core has a mesh number of 50-200 and the inner filtering core has a mesh number of 300-600.

4. The filtering device as claimed in claim 2, wherein a fourth chamber is defined between an outer periphery of the first switch device and the inner periphery of the body, the fourth chamber communicates with the first chamber, the first switch device has a recess defined in a top portion thereof to communicate with the second chamber such that the first switch device controls communication between the recess as well as the second chamber and the first chamber as well as the fourth chamber.

5. The filtering device as claimed in claim 3, wherein a fourth chamber is defined between an outer periphery of the first switch device and the inner periphery of the body, the fourth chamber communicates with the first chamber, the first switch device has a recess defined in a top portion thereof to communicate with the second chamber such that the first switch device controls communication between the recess as well as the second chamber and the first chamber as well as the fourth chamber.

6. The filtering device as claimed in claim 4, wherein a drainage is provided to a bottom of the first switch device and has a manual switch connected to the drainage to control water flow of the drainage.

7. The filtering device as claimed in claim 2, wherein the second switch device is a three-way valve device with a sleeve extending into the body and a knob operably connected to the sleeve to control rotation of the sleeve, the sleeve has an aperture defined in a side face thereof and a boss formed below the aperture to block communication between the inlet and the first chamber.

8. The filtering device as claimed in claim 6, wherein the first switch device includes:
a base with the recess defined therein; a shaft and a cover,
the shaft is composed of a disk and a rotary sleeve integrally extended downward from the disk, the disk has a cutout defined in a peripheral sidewall thereof and the base has a waterway in communication with the cutout via the recess, the rotary sleeve has a water passage defined through a side face thereof, the cover receives therein the base and the disk while the rotary sleeve extends out of the cover to engage with a knob, a bottom end of the rotary sleeve is connected to an inlet of the drainage such that when the first switch is functioning and in a closed status, water is blocked from flowing from the recess to the fourth chamber, and when the first switch device is in an open status, water flows from the recess to the fourth chamber via the waterway and the cutout of the disk, the water passage is used to allow the water in the fourth chamber to flow to the drainage via the rotary sleeve.

9. The filtering device as claimed in claim 2, wherein the first switch device includes:
a base with the recess defined therein; a shaft and a cover,
the shaft is composed of a disk and a rotary sleeve integrally extended downward from the disk, the disk has a cutout defined in a peripheral sidewall thereof and the base has a waterway in communication with the cutout via the recess, the rotary sleeve has a water passage defined through a side face thereof, the cover receives therein the base and the disk while the rotary sleeve extends out of the cover to engage with a knob, a bottom end of the rotary sleeve is connected to inlet of a drainage provided to a bottom end of the first switch device, such that when the first switch is functioning and in a closed status, water is blocked from flowing from the recess to the fourth chamber, and when the first switch device is in an open status, water flows from the recess to the fourth chamber via the waterway and the cutout of the disk, the water passage is used to allow the water in the fourth chamber to flow to the drainage via the rotary sleeve.

10. The filtering device as claimed in claim 4, wherein the first switch device includes:
a base with the recess defined therein; a shaft and a cover,
the shaft is composed of a disk and a rotary sleeve integrally extended downward from the disk, the disk has a cutout defined in a peripheral sidewall thereof and the base has a waterway in communication with the cutout via the recess, the rotary sleeve has a water passage defined through a side face thereof, the cover receives therein the base and the disk while the rotary sleeve extends out of the cover to engage with a knob, a bottom end of the rotary sleeve is connected to inlet of a drainage provided to a bottom end of the first switch device, such that when the first switch is functioning and in a closed status, water is blocked from flowing from the recess to the fourth chamber, and when the first switch device is in an open status, water flows from the recess to the fourth chamber via the waterway and the cutout of the disk, the water passage is used to allow the water in the fourth chamber to flow to the drainage via the rotary sleeve.

11. The filtering device as claimed in claim 5, wherein the first switch device includes:
a base with the recess defined therein; a shaft and a cover,
the shaft is composed of a disk and a rotary sleeve integrally extended downward from the disk, the disk has a cutout defined in a peripheral sidewall thereof and the base has a waterway in communication with the cutout via the recess, the rotary sleeve has a water passage defined through a side face thereof, the cover receives therein the base and the disk while the rotary sleeve extends out of the cover to engage with a knob, a bottom end of the rotary sleeve is connected to inlet of a drainage provided to a bottom end of the first switch device, such that when the first switch is functioning and in a closed status, water is blocked from flowing from the recess to the fourth chamber, and when the first switch device is in an open status, water flows from the recess to the fourth chamber via the waterway and the cutout of the disk, the water passage is used to allow the water in the fourth chamber to flow to the drainage via the rotary sleeve.
